(19) United States
(12) Patent Application Publication
(10) Pub. No.: US 2019/0322573 A1
(43) Pub. Date: Oct. 24, 2019

(54) GLASS ETCHING COMPOSITION AND METHOD OF MANUFACTURING ANTI-GLARE GLASS

(71) Applicant: CORNING INCORPORATED, CORNING, NY (US)

(72) Inventors: Byoung-Gwan Kang, Seoul (KR); Ji-Hoon Lee, Asan-si (KR); Ki-Yeon Lee, Suwon-si (KR); Hoon-Chul Oh, Asan-si (KR)

(21) Appl. No.: 16/470,908

(22) PCT Filed: Dec. 22, 2017
(86) PCT No.: PCT/KR2017/015392

§ 371 Date: Jun. 18, 2019

(30) Foreign Application Priority Data
Dec. 29, 2016 (KR) 10-2016-0182518
Dec. 22, 2017 (KR) 10-2017-0178099

(51) Int. Cl. C03C 15/02; C03C 3/087

(52) U.S. Cl. CPC C03C 15/02; C03C 2204/08; C03C 3/087

(57) ABSTRACT

A glass etching composition contains a base etching solution for etching glass and a syrup made from hydrolysis of starch. The syrup contains at least one selected from the group consisting of glucose, maltose, and dextrin. The base etching solution contains hydrogen fluoride, ammonium fluoride, and water. The glass etching composition further contains at least one selected from the group consisting of starch powder, Fibersol®, pectin, and guar gum. A method of manufacturing anti-glare glass includes etching glass using a first glass etching solution by screen printing. The first glass etching solution contains a base etching solution for etching glass and a syrup made from hydrolysis of starch. The glass has higher chemical durability than soda-lime glass. The method further includes etching the glass with a second glass etching solution after etching the glass using the first glass etching solution.

### BACKGROUND

### Field

The present disclosure relates to a glass etching composition and a method of manufacturing anti-glare glass. More particularly, the present disclosure relates to a glass etching composition and a method of manufacturing anti-glare glass which can impart superior anti-glare characteristics to the surface of glass while minimizing the number of required etching steps.

### Description of Related Art

A method of manufacturing anti-glare glass to impart anti-glare characteristics to the surface of glass includes a first step of forming raised structures on the surface of glass and a second step of smoothing the rough surface of glass. There are a range of conventional methods of manufacturing anti-glare glass. Most of these methods have similar second steps (slimming etching) but different first steps, and thus, the range of methods may be categorized according to the first steps thereof.

Conventional methods of manufacturing anti-glare glass may be categorized as bath-type etching, spray-type etching, screen printing etching, sandblasting, waterjet processing, and the like, depending on the type of first step. Second slimming etching must be performed, since a surface of the glass after the first step is very rough. Such rough surface may reduce uniformity of anti-glare performance and reduce strength, which are problematic. Thus, the second slimming etching step for smoothing the rough surface is inevitable.

The second slimming etching step uses a mixture of hydrogen fluoride (HF), sulfuric acid, hydrochloric acid, and the like. However, the use of such mixtures increases manufacturing costs and leads to environmental and safety-related issues. In this regard, non-fluorine based etching solutions have been developed. However, such etching solutions have the drawbacks of low efficiency and high costs. Although a lot of efforts have been made to obtain anti-glare characteristics by first processing (first etching) only, no effective methods have been reported to date.

### SUMMARY

According to an aspect, a glass etching composition may contain a base etching solution for etching glass and a syrup made from hydrolysis of starch. The syrup may contain at least one selected from the group consisting of glucose, maltose, and dextrin. The base etching solution may contain hydrogen fluoride, ammonium fluoride, and water. The glass etching composition may further contain at least one selected from the group consisting of starch powder, Fibersol®, pectin, and guar gum.

According to another aspect, a method of manufacturing anti-glare glass may include etching glass using a first glass etching solution by screen printing. The first glass etching solution may contain a base etching solution for etching glass and a syrup made from hydrolysis of starch. The glass may have higher chemical durability than soda-lime glass. The method may further include etching the glass with a second glass etching solution after etching the glass using the first glass etching solution.

As set forth above, exemplary embodiments can effectively obtain anti-glare characteristics by providing smooth roughness only with first processing. This has a superior cost saving effect and is excellent in terms of safety and environmental concerns.

The methods and apparatuses of the present disclosure have other features and advantages that will be apparent from or that are set forth in greater detail in the accompanying drawings which are incorporated herein, and in the following Detailed

Description, which together serve to explain certain principles of the present disclosure.

### BRIEF DESCRIPTION OF THE DRAWINGS

In the accompanying drawings:

FIG. 1 and FIG. 2 are scanning electron microscope (SEM) images of surfaces of pieces of glass after first etching and second etching were performed in different process conditions, the first etching being performed using an etching composition according to an exemplary embodiment;

FIG. 3 shows a low-magnification SEM image captured from a position vertically above a surface of glass after first etching was performed using a conventional etching solution, and a high-magnification SEM image thereof;

FIG. 4 shows a low-magnification SEM image captured from a position vertically above the surface of glass after second etching, subsequent to the first etching was performed, and a high-magnification SEM image thereof;

FIG. 5 shows a low-magnification SEM image captured from a position vertically above a surface of glass after first etching was performed using an etching composition according to an exemplary embodiment, and a high-magnification SEM image thereof;

FIG. 6 is an SEM image thereof captured from a position in an inclined direction;

FIG. 7 shows a high-magnification SEM image captured from a position vertically above the surface of glass after second etching, subsequent to the first etching was performed, and a high-magnification SEM image thereof;

FIG. 8 is an SEM image thereof captured from a position in an inclined direction;

FIG. 9 illustrates roughness of a surface of glass after first etching was performed using an etching composition according to an exemplary embodiment; FIG. 10 illustrates roughness of the surface of glass after second etching was performed subsequent to the first etching;

FIG. 11 is an image of a surface of glass that was marked subsequent to first etching; FIG. 12 is a microscopic image of the surface of glass from which the markings were erased; FIG. 13 is an image of a surface of glass that was first etched, second etched, and then marked; and FIG. 14 is a microscopic image of the surface of glass from which the markings were erased.

### DETAILED DESCRIPTION

Hereinafter, exemplary embodiments of the present disclosure will be described in detail with reference to the accompanying drawings.

Exemplary embodiments of the present disclosure provide a novel etching composition to impart anti-glare characteristics to the surface of glass.

An etching composition according to exemplary embodiments is manufactured by adding a syrup made from hydrolysis of starch (i.e. one or a mixture of at least two selected from among glucose, maltose, and dextrin), to a base etching solution containing hydrogen fluoride (HF). The use of the etching composition according to exemplary embodiments can form raised structures in rounded pebble-shapes on the surface of glass.

The base etching solution may consist of known components. For example, the base etching solution may contain hydrogen fluoride (HF), ammonium fluoride (NH₄FHF), and water (H₂O). The proportions of the components contained in the base etching solution may be proportions known in the art or may be specified in the present disclosure. According to an embodiment, the etching composition may contain, by weight, 8% to 24% of HF.

According to an embodiment, the etching composition may contain, by weight, 3% to 15% of NH₄FHF. According to an embodiment, sulfuric acid, nitric acid, and the like may be added to control the etching speed.

When etching is performed without the syrup made from hydrolysis of starch, slimming (i.e. a phenomenon in which the entire surface of glass is etched) may occur without properly forming raised structures imparting anti-glare characteristics, or a very rough surface may be produced. According to an embodiment, the etching composition may contain, by weight, 4% to 30% of the syrup. When starch powder is added to the etching composition, the raised structures may be more effectively formed.

According to an embodiment, the etching composition according to exemplary embodiments may further include at least one of a density modifier and a viscosity modifier.

When the density of the etching composition is increased, the adhesion between the etching composition and the glass is improved, thereby improving anti-glare effects. Starch powder is uniformly dispersed in the etching composition without reacting with HF, thereby effectively increasing the density of the etching composition. According to an embodiment, the etching composition may contain, by weight, 15% to 45% of starch powder.

In addition, Fibersol® and starch powder added to the etching composition can improve the viscosity of the etching composition, which is advantageous for uniform application of the etching composition. To additionally increase the viscosity of the etching composition, pectin, guar gum, or the like may be added to the etching composition. In addition, any existing thickener that does not react with HF and that has excellent dispersibility in aqueous solutions may be used as a density modifier. According to an embodiment, the etching composition may contain, by weight, 5% to 20% of Fibersol®. According to an embodiment, the etching composition may contain, by weight, 5% or less of pectin. According to an embodiment, the etching composition may contain, by weight, 5% or less of guar gum.

Table 1 and Table 2 represent the components of etching compositions according to examples of the present disclosure.

TABLE 1

| | | | | | | Starch- | |
|---|---|---|---|---|---|---|---|
| | | | | | | Hydro- | |
| | | | Guar | | Starch | lyzed | |
| HF | NH₄FHF | Pectin | Gum | Fibersol ® | Powder | Syrup | H₂O |
| 16.5% | 10.6% | 1.6% | 1.2% | 16.2% | 32.4% | 8.1% | 13.4% |

TABLE 2

| | | | | | | Starch- | |
|---|---|---|---|---|---|---|---|
| | | | | | | Hydro- | |
| | | | Guar | | Starch | lyzed | |
| HF | NH₄FHF | Pectin | Gum | Fibersol ® | Powder | Syrup | H₂O |
| 18.5% | 11.9% | 1.8% | 1.3% | 18.1% | 24.3% | 9.1% | 15.0% |

When the rounded pebble-shaped structures having microscopic sizes are arranged on the surface of a piece of glass, the piece of glass has anti-glare characteristics. In the related art, to obtain a smooth roughness, a first etching step of forming raised structures on the surface of glass and a second step of smoothing the rough surface are required. Thus, to perform the two steps of etching, the total processing time is increased and thus the process cost is also increased.

In contrast, the present disclosure proposes a method able to obtain smooth roughness using first etching only. According to exemplary embodiments, it is possible to perform the first etching step using screen printing, thereby imparting the surface of a piece of glass with microscopic raised structures.

The etching composition and the etching method according to exemplary embodiments can impart better etching effects to glass having higher chemical durability than existing soda-lime glass. The etching composition and the etching method according to exemplary embodiments may be effective in the etching of non-alkali glass. For example, the etching composition and the etching method according to exemplary embodiments may provide better etching effects when used to etch Eagle XG®/Willow® glass, commercially available from Corning®. Although soda-lime glass is subjected to anti-glare etching by screen printing in the related art, it may be difficult to perform anti-glare etching on glass having higher chemical durability by screen printing, due to high chemical durability thereof.

In this regard, the concentration of HF of the etching composition according to exemplary embodiments may be, by weight, 8% or higher. When the concentration of HF ranges, by weight, from 3% to 8%, etching may only be accomplished in the case in which the etching time is maintained for 3 minutes to 10 minutes. However, when the etching time exceeds 3 minutes, the thin etching composition applied to the surface of glass by screen printing may be dried, so that etching may not be properly performed. When the etching composition containing, by weight, 3% to 8% of HF is applied to at least a thickness of 1 mm to 10 mm, a very small amount of the etching composition may be dried, even after 3 minutes, so that anti-glare etching may be successfully accomplished. However, such a thick application of the etching composition cannot be regarded as appropriate screen printing. It is therefore ideal to maintain the HF concentration in the range of, by weight, 8% to 32%, apply the etching composition to a thickness of 500 pm or less by screen printing, and then perform anti-glare etching for an etching time of 3 minutes or less. The process time for the first etching may range from 10 seconds to 180 seconds.

It is possible to obtain raised structures having a variety of sizes by adjusting the components of the first etching composition and adjusting the conditions of the first etching process, thereby adjusting anti-glare characteristics. The sizes of unit raised structures (i.e. the diameters of the circumscribed circles of a unit raised structure, measured in the direction parallel to the surface of glass) are adjustable between 2 μm and 50 μm. The heights of unit raised structures (measured in the direction perpendicular, or normal, to the surface of glass) are adjustable between 0.5 μm and 5 μm. The sizes of unit raised structures are mainly influenced by the components of the etching composition, such as the sizes and fraction of starch powder and the fraction of a starch-hydrolyzed syrup. The heights of unit raised structures are mainly influenced by process conditions, such as an etching time, an etching temperature, and the amount of the etching composition applied by screen printing. The sizes and heights of unit raised structures may be adjusted by modifying the components of the etching composition and the etching process conditions.

In addition, according to exemplary embodiments, a second etching step may be performed as an auxiliary step. In the second etching step, second etching known in the art may be performed. The second etching known in the art may be slimming etching.

Table 3 represents anti-glare characteristics measured on groups of glass, after the groups of glass were subjected to first etching with the same etching composition for different etching times and then second etching.

TABLE 3

| | Gloss | Ra | Haze |
|---|---|---|---|
| Group A | 20 to 24 | 0.310 to 0.350 | 22 to 26 |
| Group B | 34 to 36 | 0.270 to 0.300 | 14 to 18 |
| Group C | 40 to 44 | 0.240 to 0.260 | 10 to 14 |

The etching method according to exemplary embodiments can obtain a variety of haze levels ranging from 5% to 80% by adjusting process conditions (e.g. process times).

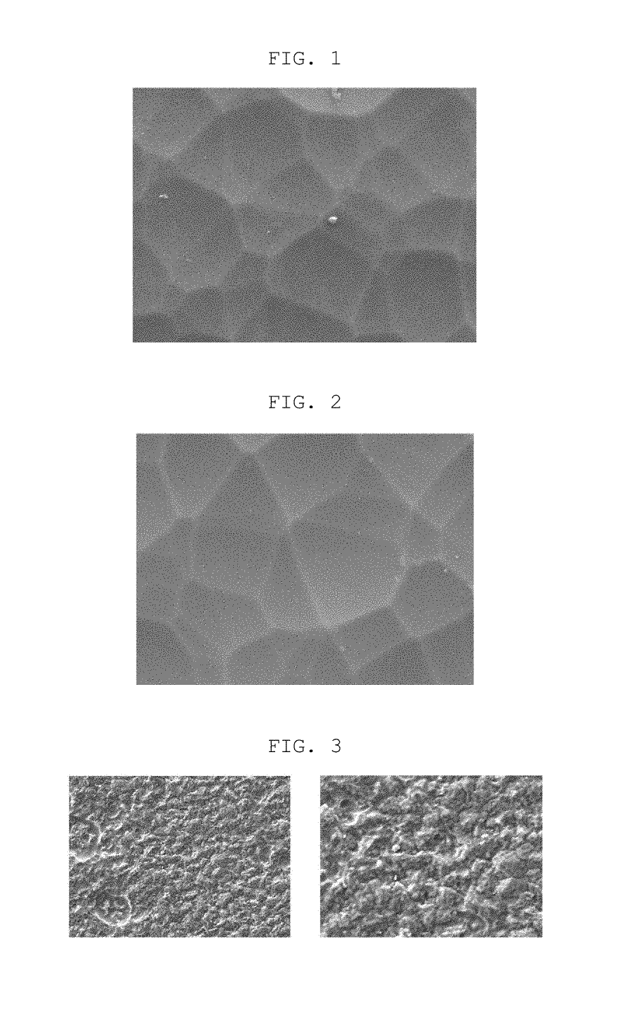

FIG. 1 is a scanning electron microscope (SEM) image of a surface of glass belonging to group A in Table 3, while FIG. 2 is an SEM image of a surface of glass belonging to group B in Table 3.

After first etching, a process of abrading higher portions of raised structures by applying friction to the surface of glass using a brush may be added.

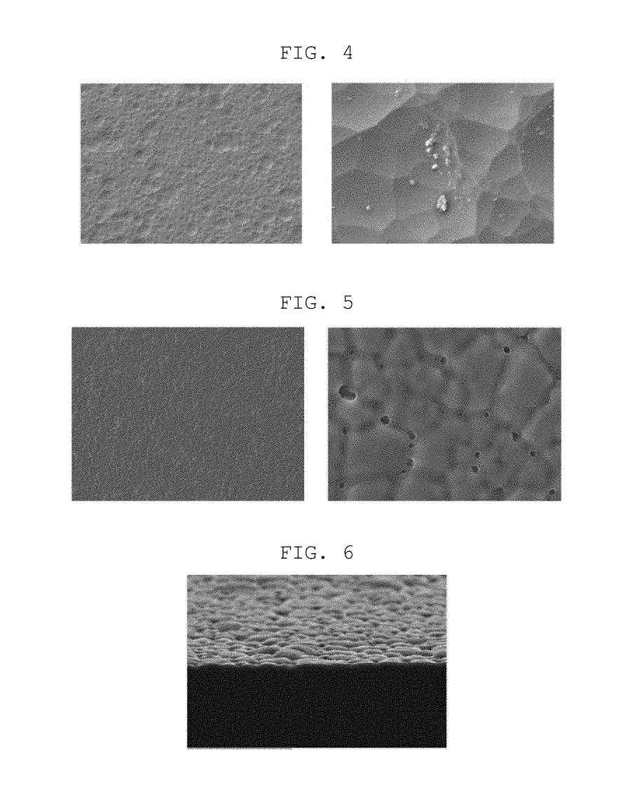

FIG. 3 shows a low-magnification SEM image captured from a position vertically above a surface of glass after first etching was performed using a conventional etching solution, and a high-magnification SEM image thereof. In addition, FIG. 4 shows a low-magnification SEM image captured from a position vertically above a surface of glass after second etching, subsequent to the first etching was performed, and a high-magnification SEM image thereof.

Soda-lime glass was etched. As illustrated in FIG. 3, when first etching was performed using a conventional etching solution by screen printing, the formation of raised structures resulted. However, resultant glass could not be used in that state, since the overall surface of glass was excessively rough and non-uniform. Thus, after second etching was performed as illustrated in FIG. 4, a smooth surface was formed.

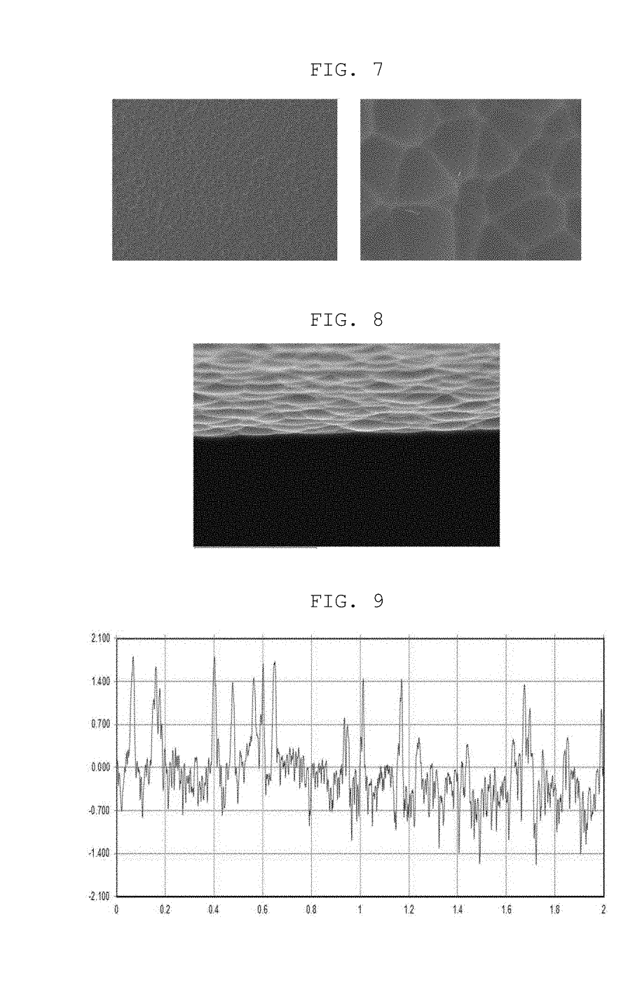

FIG. 5 shows a low-magnification SEM image captured from a position vertically above a surface of glass after first etching was performed using an etching composition according to an exemplary embodiment, and a high-magnification SEM image thereof. FIG. 6 is an SEM image thereof captured from a position in an inclined direction (in which the top and side surfaces of glass were illustrated). In addition, FIG. 7 shows a high-magnification SEM image captured from a position vertically above the surface of glass after second etching, subsequent to the first etching was performed, and a high-magnification SEM image thereof. FIG. 8 is an SEM image thereof captured from a position in an inclined direction (in which the top and side surfaces of glass were illustrated).

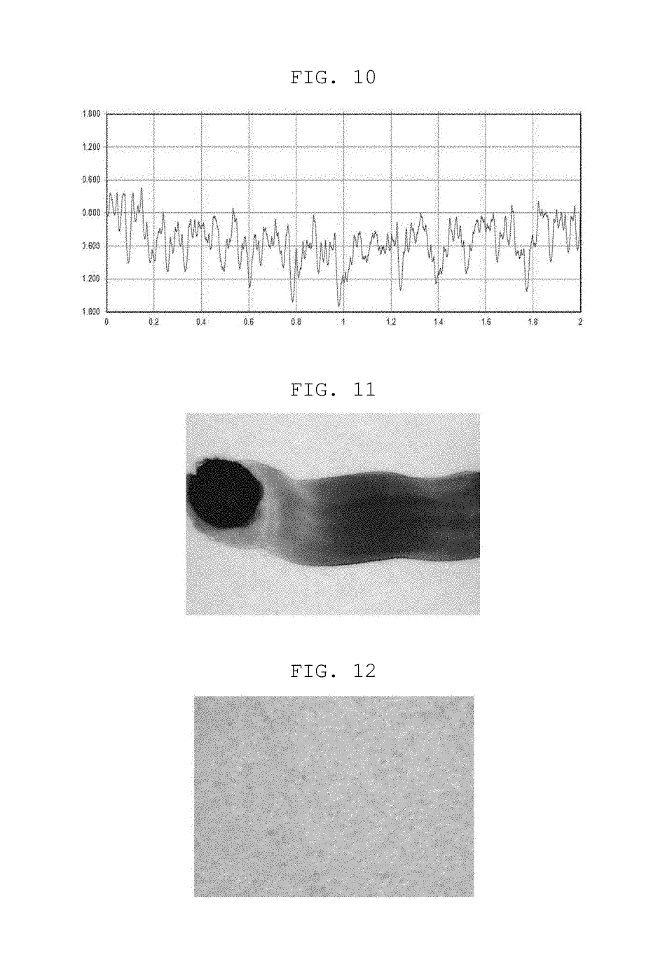

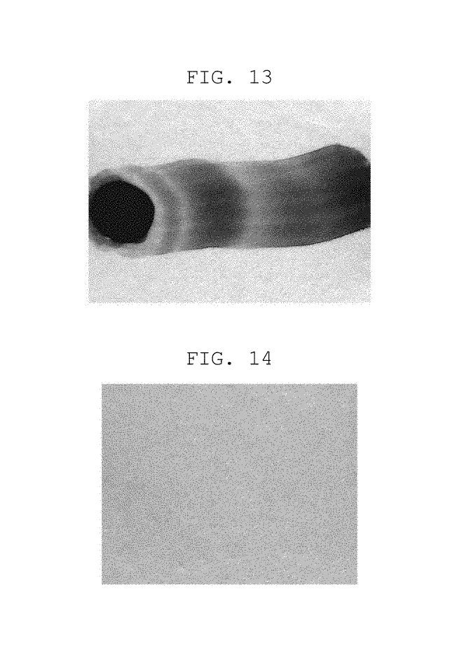

Eagle XG®/Willow® glass commercially available from Corning® was used. The first etching was performed by screen printing using the etching composition according to the exemplary embodiment. (This is the same as in images illustrated in FIG. 9 to FIG. 14.) When glass was only subjected to the first etching using the etching composition according to the exemplary embodiment, a smoothly and regularly textured surface was produced (Ra=0.353 to 0.396; see FIG. 5 to FIG. 6). In addition, when the first etching and the second etching were performed sequentially, a smoothly textured surface as in the conventional method was produced (Ra=0.270 to 0.300; see FIG. 7 to FIG. 8).

The level of roughness Ra obtainable by performing the first etching using the etching composition according to the exemplary embodiment may be in the range of 0.150 μm to 2.500 μm, and preferably, 0.200 μm to 1.000 μm. The level of roughness Ra obtainable by performing the second etching, subsequent to the first etching, may be in the range of 0.100 μm to 1.500 μm, and preferably, 0.150 μm to 0.800 μm.

FIG. 9 illustrates roughness of a surface of glass after first etching was performed using an etching composition according to an exemplary embodiment, while FIG. 10 illustrates roughness of a surface of glass after second etching was performed, subsequent to the first etching.

A SURFCOM 130, a contact-type contacting surface roughness measuring instrument, was used in the measurements. The unit of the horizontal axis is millimeters, while the unit of the vertical axis is micrometers.

The anti-glare glass according to exemplary embodiments can be used for a range of applications. For example, the inventor tested the application of the anti-glare glass according to exemplary embodiments for a marker board.

Table 4 represents an analysis of the optical characteristics of anti-glare glass.

TABLE 4

| | Gloss | Ra (μm) | Haze (%) |
|---|---|---|---|
| After 1^{st} Etching | 17.9 | 0.353 to 0.396 | 65.28 |
| After 1^{st} Etching, Marking, | 23.3 | No changes | 45.46 |
| and Erasion of Marks | | (0.353 to 0.396) | |
| After 1^{st} Etching and | 34 to 36 | 0.270 to 0.300 | 14 to 18 |
| 2^{nd} Etching | | | |
| After 1^{st} Etching, | 23.7 to 27.2 | No changes | 23 to 27 |
| 2^{nd} Etching, Marking, | | (0.270 to 0.300) | |
| and Erasion of Marks | | | |

FIG. 11 is an image of a surface of glass that was marked subsequent to first etching, FIG. 12 is a microscopic image of a surface of glass from which the markings were erased, FIG. 13 is an image of a surface of glass that was first etched, second etched, and then marked, and FIG. 14 is a microscopic image of a surface of glass from which the markings were erased.

The foregoing descriptions of specific exemplary embodiments of the present disclosure have been presented with respect to the drawings. They are not intended to be exhaustive or to limit the present disclosure to the precise forms disclosed herein, and many modifications and variations are obviously possible for a person having ordinary skill in the art in light of the above teachings.

It is intended therefore that the scope of the present disclosure not be limited to the foregoing embodiments, but be defined by the Claims appended hereto and their equivalents.

What is claimed is:

1. A glass etching composition comprising:
a base etching solution for etching glass; and
a syrup made from hydrolysis of starch.

2. The glass etching composition of claim 1, wherein the syrup comprises at least one selected from the group consisting of glucose, maltose, and dextrin.

3. The glass etching composition of claim 1, wherein the base etching solution comprises hydrogen fluoride.

4. The glass etching composition of claim 3, wherein the base etching solution further comprises ammonium fluoride and water.

5. The glass etching composition of claim 4, the glass etching composition comprising, by weight, 8% to 24% of the hydrogen fluoride and 3% to 15% of the ammonium fluoride.

6. The glass etching composition of claim 3, wherein the base etching solution further comprises at least one of sulfuric acid and nitric acid.

7. The glass etching composition of claim 1, further comprising at least one of a density modifier and a viscosity modifier.

8. The glass etching composition of claim 1, further comprising at least one selected from the group consisting of starch powder, Fibersol®, pectin, and guar gum.

9. A method of manufacturing anti-glare glass, comprising etching glass using a first glass etching solution by screen printing, wherein the first glass etching solution comprises:
a base etching solution for etching glass; and
a syrup made from hydrolysis of starch.

10. The method of claim 9, wherein the glass has higher chemical durability than soda-lime glass.

11. The method of claim 9, wherein the glass is non-alkali glass.

12. The method of claim 9, wherein etching the glass using the first glass etching solution is performed for 10 seconds to 180 seconds.

13. The method of claim 9, wherein the first glass etching solution is applied to the glass to a thickness of 500 μm or less.

14. The method of claim 9, wherein when etching the glass using the first glass etching solution causes raised structures to be formed on a surface of the glass, sizes of the raised structures ranges from 2 μm to 50 μm when measured in a direction parallel to the surface of the glass.

15. The method of claim 9, wherein when etching the glass using the first glass etching solution causes raised structures to be formed on a surface of the glass, heights of the raised structures range from 0.5 μm to 5 μm when measured in a direction normal to the surface of the glass.

16. The method of claim 9, wherein etching the glass using the first glass etching solution imparts a roughness (Ra) ranging from 0.150 to 2.500 to the glass.

17. The method of claim 9, wherein etching the glass using the first glass etching solution imparts haze ranging from 5% to 80% to the glass.

18. The method of claim 9, further comprising etching the glass with a second glass etching solution after etching the glass using the first glass etching solution.

19. The method of claim 18, wherein etching the glass with the second glass etching solution imparts a roughness (Ra) ranging from 0.100 to 1.500 to the glass.

20. The method of claim 9, wherein the glass is glass for a marker board.
